(19) United States
(12) Patent Application Publication
(10) Pub. No.: US 2015/0107527 A1
(43) Pub. Date: Apr. 23, 2015

(54) PORTABLE DEVICE FOR PROTECTING A NEST BOX

(71) Applicant: ROTECNA S.A., Agramunt (ES)

(72) Inventor: Gener ROMEU GUARDIA, Agramunt (ES)

(73) Assignee: ROTECNA S.A., Agramunt (ES)

(21) Appl. No.: 14/510,888

(22) Filed: Oct. 9, 2014

(30) Foreign Application Priority Data
Oct. 22, 2013 (ES) 201331208

(51) Int. Cl. A01K 1/02; A01K 29/00

(52) U.S. Cl. CPC A01K 1/0218; A01K 1/0209; A01K 1/0227; A01K 29/00
USPC 119/503

(57) ABSTRACT

A portable device for protecting a nest box, such as for piglets, having a first cover and second cover that are attached to one another in an articulated manner by at least one hinge configured for providing the device with a support on the upper edge of a partition wall, such as a partition wall of pigpens, in a folded transport position in which the first cover and second cover are arranged above the support of the hinge on the partition, and also with a stable support in a deployed operating position in which each cover is arranged below the support point of the hinge on the partition, providing protection for a nest box located on the side of the partition on which the cover extends.

### TECHNICAL FIELD OF THE INVENTION

The invention relates to a portable device for protecting a nest box, particularly suitable for protecting two nest boxes for piglets separated by a partition wall.

### BACKGROUND OF THE INVENTION

Conventional nest boxes or farrowing crates for piglets generally consist of pens provided with an opening so that the animals can come and go. Such pens are supported on the floor of the pig housing and comprise walls and a cover. These nest boxes have a complicated construction and high cost.

Plates placed a certain distance from the floor in a corner of the pig housing, the walls or the partitions of the pig housing acting as side walls of the nest box, are known as an alternative to these nest boxes. Such alternatives provide protection for a partially closed floor surface of the pig housing by means of two of their sides and by means of walls or partition walls of the pig housing.

This is the case of the device described in Utility Model ES267690. According to this device, an arched plate is arranged in a corner of the pig housing which is articulated by means of a tie linked to the ceiling or other raised point of the pig housing, such that the angular position of the plate can changed between one raised position and another in which it is supported on the floor making it possible to adjust the volume and temperature of the nest box according to the size and age of the piglets.

This solution has several drawbacks, among which it is worth pointing out that it requires a prior installation to be able to manage the height of the plate in the sense that the location of the plate cannot be changed without detaching it from the raised point of the pig housing to which the tie is attached, and the tie must be again attached to the raised point immediately about the new location of the nest box. On the other hand, the articulated plate comprises an elongated support which is fixed to a side wall of the pig housing with suitable means, such as screws or the like, thereby acting as a side enclosure for the nest box. Although said support is envisaged as being detachable, the lack of a system which allows installing and uninstalling the plate without needing to use tools or auxiliary components such as screws, hold-down nuts, etc., to perform this operation must be pointed out.

Portable devices having fitting members in the partition wall are also known. Nevertheless, said devices do not allow a quick installation because they require an operator to align the fitting member of each device with the partition wall before inserting it. This operation can complicate, and therefore delay, installation of multiple devices in large facilities.

Furthermore, these known devices provided with fitting members require a completely straight partition wall with no irregularities or bulging that could complicate or even impede inserting the fitting member in the partition wall.

An objective of the present invention is to therefore disclose a portable device that can be readily installed and allows quickly protecting a nest box, such as a nest box for piglets.

### DISCLOSURE OF THE INVENTION

The device of the invention is a portable device particularly suitable for protecting a nest box, such as a nest box for piglets, of the type comprising a first cover and second cover.

The device is essentially characterized in that said first cover and second cover are attached to one another in an articulated manner by means of at least one hinge configured for providing the device with a support on the upper edge of a partition wall, such as a partition wall of pigpens, in a folded transport position in which the first cover and second cover are arranged above the support of the hinge on the partition, and with a stable support in a deployed operating position in which each cover is arranged below the support point of the hinge on the partition providing protection for a nest box located on the side of the partition on which the cover extends, allowing greater speed when arranging the device for protecting a nest box, such as a nest box for piglets.

It is also hereby disclosed that the device comprises two or more hinges articulated about a common imaginary axis forming coplanar support points for the device between such hinges which allow folding and deploying the device and the transition thereof between the folded transport position and the deployed operating position.

According to one way of putting the present invention into practice, each hinge is formed by two parts attached to one another and rotational about a pin going through them, each part being formed in one of the covers, each cover therefore being firmly attached to its respective part of the hinge and allowing articulation to one another.

It is also hereby disclosed that the parts forming each hinge are bent, determining respective elbows which allow determining a blunt support point in the folded transport position and holding the device when it is clamped onto the partition in the deployed operating position.

According to another feature of the invention, the side flap extends from the cover to the elbow of the parts of each hinge in an essentially perpendicular manner, each side flap being supported on the side edge of the partition in the deployed operating position.

It is also hereby disclosed that the parts of each hinge are attached to the side flap of said cover, determining ribs acting like stiffeners reinforcing the attachment between the parts of each hinge and the cover and allowing an extension of its service life.

Preferably, the elbows of each hinge determine a 90 degree angle to enable being supported on the upper edge of the partition, clamped to the side wall of said partition.

According to another feature of the invention, the parts forming each hinge are crossed in the folded transport position, and the parts forming each hinge are not crossed in the deployed operating position, determining a blunt support point on the partition in the folded transport position.

According to another feature, each cover is provided with a handle attached to the cover in a fixed or articulated manner, the dimensions of the handles being such that when both covers adopt their raised position, said handles can be arranged side by side or close enough to one another so that a single hand can be used to grip them for transporting the device.

Advantageously, by simply releasing the handles of the device after being supported on the upper edge of a partition, the device will be quickly deployed, adopting the deployed operating position.

According to another feature, the device is provided with a system for attaching the two covers to one another or keeping them linked to one another in the folded transport position, or in a position very close to said folded transport position, retaining them in this position, such as a hook.

According to another feature of the device, at least one of the covers is provided with a through hole closed by a detachable lid, the holes being provided with seating means which allow coupling a lamp when the lid is removed.

It is also hereby disclosed that the covers are provided with a downwardly-oriented perimetral skirt extending around the cover with the exception of the side of the cover through which such covers are attached in an articulated manner by means of their corresponding hinges to protect the nest box.

### BRIEF DESCRIPTION OF THE DRAWINGS

The attached drawings illustrate an embodiment of the portable device for protecting a nest box object of the invention by way of non-limiting example. In said drawings:

FIG. 1 shows a view of the portable device according to the invention in the folded transport position on the upper edge of a partition of a pig housing in the manner in which it is arranged when a user grips it;

FIG. 2 shows a view of the portable device of the invention in the deployed operating position correctly installed on the upper edge of the partition of the pig housing.

### DETAILED DESCRIPTION OF A VARIANT OF THE INVENTION

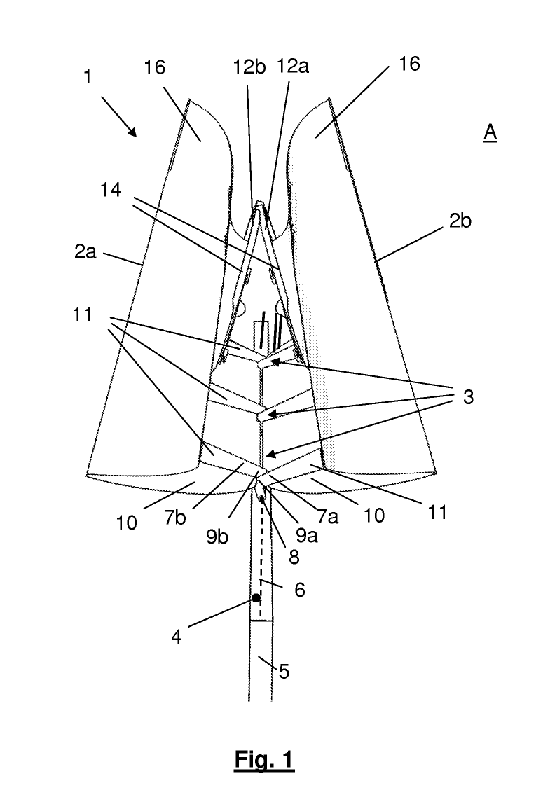

The portable device 1 shown in FIG. 1 basically comprises a first cover and second cover 2a, 2b, said first cover and second cover 2a, 2b being attached to one another in an articulated manner by means of at least one hinge 3 configured for providing the device 1 with a support on the upper edge 4 of a partition wall 5 of pigpens in a folded transport position A in which the first cover and second cover 2a, 2b are arranged above the support of the hinge 3 on the partition 5 as shown in FIG. 1. Although the device 1 shown in FIG. 1 comprises three hinges 3 articulated about a common imaginary axis 6 forming coplanar support points for the device 1 between such hinges, it could also have a different number of hinges, such as two or more hinges 3. The covers 2a, 2b are provided with a perimetral skirt 16 extending around each cover with the exception of the side of the cover through which such covers are attached in an articulated manner by means of their corresponding hinges 3.

Each hinge 3 is formed by two parts 7a, 7b attached to one another and rotational about a pin 8 going through them, each part being formed in one of the covers 2a, 2b. These parts 7a, 7b forming each hinge 3 are furthermore bent, determining respective elbows 9a, 9b determining a 90 degree angle, and said parts 7a, 7b forming each hinge 3 are crossed in the folded transport position A shown in FIG. 1.

To make this transport operation easier, each cover 2a, 2b is provided with a handle 12a, 12b that is firmly attached or articulated to its respective cover 2a, 2b, such handles being arranged and the dimensions thereof being such that said handles 12a, 12b are arranged side by side or close enough to one another so that when both covers are in the folded transport position A, a single hand can be used to grip said handles 12a, 12b for transporting the device 1.

On the other hand, it has been contemplated that the device 1 be provided with a system for keeping the two covers 2a, 2b attached to one another in the stable folded transport position A, the device 1 adopting the folded form shown in FIG. 1. For that purpose, it has been envisaged that the first cover 2a be provided with a hook or the like, for example, which hooks onto or engages a projection provided for this purpose in the second cover 2b, when they are both in the mentioned folded position. In the example of FIG. 1, the aforementioned system comprises a hook linking the two covers 2a, 2b to one another through their handles 12a and 12b.

Advantageously, to install the device 1 to cover a nest box for piglets, the operator transporting the device 1 must simply support the hinges 3 on the partition 5 and release the handles 12a, 12b, such that the hinges 3 are stably supported in a deployed operating position B of the device 1, in which each cover 2a, 2b is arranged below the support point of the hinge 3 on the partition 5, providing protection for a nest box located on the side of the partition 5 on which the cover extends 2a, 2b. It can be seen in said deployed operating position B that the perimetral skirts 16 of each cover 2a, 2b are downwardly oriented, extending around each cover with the exception of the side of the cover 2a, 2b through which such covers are attached in an articulated manner by means of their corresponding hinges 3, thus protecting the nest box.

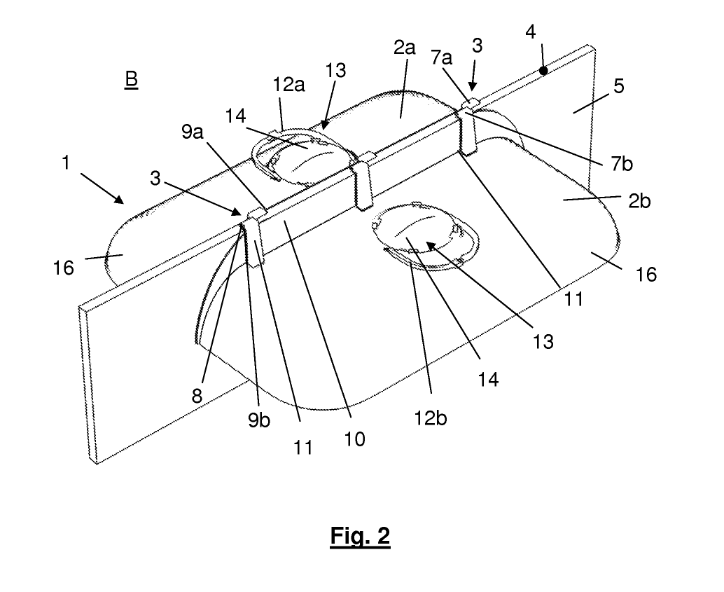

Since the parts 7a, 7b forming each hinge 3 are bent, when the covers 2a, 2b are deployed the elbows 9a, 9b are advantageously arranged such that they are clamped onto the upper edge 4 of the partition 5, as shown in FIG. 2. The operator therefore does not have to perfectly center the device 1 on the partition 5 before the device adopts the deployed operating position B, because when the elbows 9a, 9b are clamped onto the upper edge 4 of the partition 5 in deployment, they will correctly and stably center the device 1 on said partition 5. Faster installation of the device 1 is therefore achieved. It is observed that while the parts forming each hinge 3 are crossed in the folded transport position A, determining a single blunt point on which the hinge 3 can be supported on the upper edge 4 of the partition 5 to make placement easier, the parts forming each hinge 3 are not crossed in the deployed operating position B, the entire hinge 3 being supported on the partition 5, the elbows 9a, 9b thereof clamping onto the upper edge 4 to assure securing thereof.

To improve placing the device 1 in the deployed operating position B, each cover 2a, 2b further comprises a side flap 10 extending from each cover 2a, 2b to the elbow 9a, 9b of the parts 7a, 7b forming each hinge 3 of the cover 2a, 2b in an essentially perpendicular manner to assure securing thereof.

To reinforce the securing of the covers 2a, 2b by the hinges 3, the parts 7a, 7b of each hinge 3 are attached to the side flap 10 of the cover 2a, 2b by means of a thick portion of material determining a rib 11 acting like a stiffener reinforcing the attachment between the hinge 3 and the covers 2a, 2b.

In a known manner, as shown in FIG. 2 the invention also contemplates providing at least one of the covers 2a, 2b with a through hole 13 closed by a detachable lid 14, the hole being provided with seating means which allow coupling a lamp when the lid 14 is removed. This feature makes the device 1 compatible with the means conventionally used for providing heat to a nest box, which use lamps or lights. In addition to providing a single cover for a hole, the inventors envisage the manufacture of two other different variants for the device according to the invention: with the two covers provided with respective holes, and with the two covers not having a hole.

1. A portable device for protecting a nest box, such as a nest box for piglets, comprising a first cover and second cover, characterized in that said first cover and second cover are attached to one another in an articulated manner by means of at least one hinge configured for providing the device with a support on the upper edge of a partition wall, such as a partition wall of pigpens, in a folded transport position in which the first cover and second cover are arranged above the support of the hinge on the partition, and with a stable support in a deployed operating position in which each cover is arranged below the support point of the hinge on the partition, providing protection for a nest box located on the side of the partition on which the cover extends.

2. The device according to claim 1, characterized in that it comprises two or more hinges articulated about a common imaginary axis forming coplanar support points for the device between such hinges.

3. The device according to claim 1, characterized in that each hinge is formed by two parts attached to one another and rotational about a pin going through them, each part being formed in one of the covers.

4. The device according to claim 1, characterized in that the parts forming each hinge are bent, determining respective elbows.

5. The device according to claim 1, characterized in that each cover comprises a side flap extending from said cover to the elbow of the parts of each hinge of said cover in an essentially perpendicular manner.

6. The device according to claim 1, characterized in that the parts of each hinge are attached to the side flap of said cover determining ribs acting like stiffeners.

7. The device according to claim 4, characterized in that the elbows of each hinge determine a 90 degree angle.

8. The device according to claim 1, characterized in that the parts forming each hinge are crossed in the folded transport position, and the parts forming each hinge are not crossed in the deployed operating position.

9. The device according to claim 1, characterized in that each cover is provided with a handle that is firmly attached or articulated to the cover, the handles being arranged and the dimensions thereof being such that in the folded transport position said handles can be arranged side by side or close enough to one another so that a single hand can be used to grip them for transporting the device.

10. The device according to claim 1, characterized in that it is provided with a system for attaching the two covers to one another or keeping them linked to one another in the folded transport position or in a position very close to said folded transport position, retaining them in this position.

11. The device according to claim 1, characterized in that at least one of the covers is provided with a through hole closed by a detachable lid, the hole being provided with seating means which allow coupling a lamp when the lid is removed.

12. The device according to claim 1, characterized in that the covers are provided with a downwardly-oriented perimetral skirt extending around the cover with the exception of the side of the cover through which such covers are attached in an articulated manner by means of their corresponding hinges.
